(19) United States
(12) Patent Application Publication
(10) Pub. No.: US 2024/0043727 A1
(43) Pub. Date: Feb. 8, 2024

(54) BIO-BASED, MULTIPURPOSE TWO-PART ADHESIVE

(71) Applicant: Viridis Technologies, LLC, Romeoville, IL (US)

(72) Inventor: Lance K. Niemann, Prescott Valley, AZ (US)

(21) Appl. No.: 18/135,772

(22) Filed: Apr. 18, 2023

Related U.S. Application Data
(60) Provisional application No. 63/394,761, filed on Aug. 3, 2022.

(51) Int. Cl. C09J 175/06

(52) U.S. Cl. CPC C09J 175/06

(57) ABSTRACT

A polyurethane adhesive including an A side component having a reactive organic diisocyanate and a B side component having hydroxylated plant-based oil, phosphated plant-based oil, and optionally, at least one of a catalyst, a surfactant, water, and a trace amount of A side component.

### BACKGROUND

### Cross Reference to Other Application

This application claims the benefit of and priority to U.S. Provisional Application No. 63/394,761 filed Aug. 3, 2022, the contents of which are incorporated by reference.

### FIELD OF DISCLOSURE

This disclosure relates to adhesive compositions, and in particular to adhesive compositions which contain a major proportion of bio-based components and have a Volatile Organic Content (“VOC”) between zero and 2 percent.

Brief Statement of the Prior Art

The vast majority of adhesives currently marketed are based on petroleum derived components. Typical of these are acrylic, urethane and epoxy adhesives. Urethane adhesives are widely used in various fields such in roofing and flooring for the construction industry, in bonding wood fibers and chips into boards for the lumber industry, in the footwear industry and for numerous applications in packaging operations, since the physical properties of the adhesive can be widely varied. Although single component urethane adhesives and hot melts which use polyurethane dissolved in a volatile solvent or a reactive prepolymer are available, the majority of urethane adhesives use two reactive components, commonly referred to as the A and B sides, which, respectively, are an isocyanate and an organic reactive polyol. These are usually methylene diphenyl diisocyanate for the A side, and a polyether such as polypropylene glycol or a polyester polyol such as ethylene adipate diol for the B side.

The urethane adhesives currently in use are derived almost entirely from petroleum sources and are therefore subject to price fluctuation and availability of petroleum and natural gas which are dictated by the demands of the energy markets, the steadily dwindling gas and oil supplies and the volatility of international politics.

Bio-based sources such as soybean oil, castor oil, palm oil, etc. have been suggested as substitutes for the polyols in the B side of the urethane reactants, particularly for manufacture of foam products, as they provide the promise of a relatively stable, renewable raw material source. Examples are U.S. Pat. No. 6,624,244 which discloses the use of blown soybean oil and a multi-functional polyol such as ethylene glycol to react with an isocyanate and blowing agent to form a urethane foam; and U.S. Pat. No. 6,649,667 which discloses the reaction of an isocyanate and a polyol containing a vegetable oil in a reaction-injection-molded (RIM) process to produce a closed cell polyurethane foam.

U.S. Pat. No. 4,546,120 discloses polyurethane foams and coatings which are formed by the reaction of an organic polyisocyanate with an epoxidized fatty alcohol which can be derived from vegetable oils. Adhesive products are not formed and the method of this patent entails extensive pretreatment of the oil to obtain a reactive polyol with a high hydroxyl number.

Therefore, there exists a need for adhesive compositions that are substantially comprised of bio-based components and have a Volatile Organic Content between zero and 2 percent.

An aspect of this disclosure is directed to an adhesive which is based, in part, on a renewable, plant source, preferably a vegetable source.

Another aspect of this disclosure is directed to an adhesive having the majority of its composition based on a renewable plant source, preferably a vegetable source.

A further aspect of this disclosure is directed to an adhesive composition which can be formulated to various physical properties required for a selected application.

Another further aspect of this disclosure is directed to an adhesive urethane composition which minimizes the quantity of reactive organic isocyanate.

A still further aspect of this disclosure is directed to an adhesive urethane composition which maximizes the quantity of bio-based components.

Another still further aspect of this disclosure is directed to an adhesive with components that have no or negligible amounts of Volatile Organic Compounds. Other and related aspects will be apparent from the following descriptions.

### DESCRIPTION OF PREFERRED EMBODIMENTS

Generally, this disclosure comprises a two-part urethane adhesive in which the B side is partially derived from a plant oil, preferably a vegetable oil, and more preferably soybean oil. Specifically, the reactant portion of the B side may be composed of one or more derivatives of vegetable oil. Preferably, the B side comprises from 60 to 90 weight percent of a hydroxylated soybean oil; and optionally also includes from 0 to 15 weight percent of a phosphated soybean oil; 1 to 10 weight percent water (if so desired); and minor amounts of catalysts and surfactant in relation to the whole. The A and B sides are admixed in weight proportions of 15 to 40 parts organic polyisocyanate (A side) and 60 to 85 parts polyol (B side) per 100 parts of adhesive.

When maximum adhesion is desired, the A and B sides are admixed in weight proportions of 35-40 parts organic polyisocyanate (A side) with from 60 to 65 parts of B side, with the B side comprising at least a phosphated soybean oil in concentrations of 5 to 15 weight percent, and a hydroxylated soybean oil with a high hydroxyl number is used in concentrations of 20 to 50 weight percent. Preferably, a tin catalyst and an alkyl diethylene diamine co-catalyst are also used in the B side to minimize cure time of the adhesive, although other catalysts (as addressed herein) are also desirable. Preferably, the B side may also include water used in a concentration of 4 weight percent, a silicone-based surfactant, such as DC-198 from Surfynyl, or any other similar suitable product, used in a concentration of 1.5 weight percent, and/or a catalyst, such as Polycat 5 foam stabilizer from Evonix, or any other similar suitable product, used in a concentration of 1.2 weight percent.

The urethane adhesive of this disclosure is formed by mixing A and B sides (reactants). The A side reactant comprises an organic polyisocyanate such as commonly used as a reactant in polyurethane manufacture. Included in useful polyisocyanates are those based on monomers such as 4,4′ diphenylmethane diisocyanate; 2,4′ diphenylmethane diisocyanate; toluene diisocyanate, 2,4′ toluene diisocyanate, etc. The preferred polyisocyanate is based on 4,4′ diphenylmethane diisocyanate known as Mondur M R or Mondur 489, or any other similar suitable product, which have a NCO content of 31.5% and a viscosity from 150-700 cps at 25° C. and which are available from Bayer Corporation.

The B side reactant is comprised essentially of a plant-based oil derivative. Preferably two derivatives are used; the major derivative is a hydroxylated plant-based oil and the minor derivative is a phosphated plant-based oil.

For the hydroxylated plant-based oil, suitable hydroxylated soybean oils for this application are available commercially from Urethane Soy Systems under the trade designations RS-170, P38N, GC5N and R2-052, or any other similar suitable product. Alternatively, the hydroxylated plant-based oil can be prepared by hydrolyzing a raw, blown or boiled plant-based oil. Various plant-based oils can be selected as the raw material source for the hydroxylated oil, including olive oil, corn oil, sunflower oil, safflower oil, castor oil, linseed oil, soybean oil etc. Preferably, the resulting crude oil is permitted to settle to separate gums and other insoluble and congeneric impurities such as color bodies and phospholipids. The oil layer is removed and can be further treated with an alkali to remove free fatty acids which may be present. The preferred plant-based oil is soybean oil because of its availability and high content of triglycerides of unsaturated fatty acids such as linoleic, oleic and linolenic acids and lesser contents of triglycerides of saturated fatty acids such as palmitic and stearic acids. Additionally, soybean oil is renewable, economically priced and is a large domestically produced crop, thereby supporting domestic farmers.

The hydroxylated plant-based oil can also be prepared in the following manner. The plant-based oil can be epoxidized by reaction with a peroxide such as hydrogen peroxide, and per-organic acids, such as peracetic acid, perbenzoic acid, etc. The plant-based oils can also be epoxidized by reaction with oxygen. The most preferred preparation is the oxidation of soybean oil, preferably by blowing air through the soybean oil for a sufficient time, from 180 to about 600 minutes at a temperature from ambient to about 320F, sufficient to oxidize the unsaturated groups of the triglyceride esters in the soybean oil. Alternatively, blown plant-based oils such as blown soybean oil are commercially available from the ADM Company.

The blown soybean oil is then hydrolyzed to form hydroxyl groups, thus preparing a reactive polyol. The hydrolysis is preferably conducted by reacting the blown soybean oil with water at a temperature from 340° F. To about 390° F. over a time from 5 to about 10 hours, to prepare a hydroxylated soybean oil having a hydroxyl number from 50 to 190, depending on the degree of adhesion desired and cure time in the final adhesive composition. For adhesive compositions requiring high adhesion, such as, rigid roofing insulation, for example, panels for industrial roofs, and other similar high strength applications, a hydroxylated derivative having a hydroxyl number in the high end of the range, e.g., from 135 to 190 is preferable. For less adhesive products, such as those to be applied as a carpet adhesive or other medium to low strength applications, hydroxylated soybean oil having a hydroxyl number from 50 to about 135 is preferable.

The phosphated plant-based oil derivative may be prepared from epoxidized soybean oil by adding concentrated phosphoric acid (70% to 72% P₂O₅) to the plant-based oil at concentrations of 0.5 to 1.5 weight percent in the oil. An exothermic reaction occurs and the reaction is continued, while stirring, for 5 to 15 minutes. The treated soybean oil which contains tri-phosphate esters is then heated to a temperature from 95° F. to 120° F., preferably 110° F. and water and a small amount of phosphoric acid is added to hydrolyze the esters. This reaction is continued to prepare a phosphated plant-based oil containing from 1 to 3.5 weight percent phosphorus chemically bonded to the oil. The phosphated plant-based oil derivative functions to increase the adhesion of the adhesive composition and, therefore, is used in variable concentrations, depending on the degree of adhesion desired in the final adhesive.

When it is desired to have an expanded (e.g. foaming) adhesive, such as, rigid roofing insulation, for example, panels for industrial roofs, and other similar high strength applications, water can be added to the B side reactant to foam the adhesive during curing. Depending on the application and extent of foaming desired, water can be added to the B side reactant in an amount from 0.5 to 15 weight percent. When water is added, a surfactant, preferably a silicone surfactant, is also added to the B side reactant to improve or stabilize the cell structure of the foamed adhesive. An example of a suitable surfactants are DC-198 and DC-193 from Air Products or any other similar suitable product, which are silicone polyether surfactants. As a result, with respect to the rigid roofing insulation panel example, the foam is pliable and conforms to the uneven surface of the roof to maintain good adhesion to the insulation membrane.

The B side reactant can also contain various other additives, such as catalysts to reduce the cure time of the adhesive. Suitable catalysts include organic compounds of metals such as bismuth tin and zinc. Examples of these are: bismuth or zinc neodecanoate, dibutyltin dilaurate, dibutyltin diacetate, etc. Preferably organic tin compounds are used. Additional catalysts include tertiary amines, pentamethyl diethylene diamine, and other suitable catalysts as would be understood by one of ordinary skill in the art.

The A and B components of the adhesive are admixed together in proportions from 15 to about 45 parts of the A component to 85 to 55 parts of the B component. Preferably, the minimum amount of the diisocyanate (A side) is used, e.g., from about 30 to 40 parts A component, with from about 80 to 60 weight parts B component. The VOC of the resultant adhesive will be minimal to zero V.O.C. per ASTM Method D 2369, in accordance with Federal Method 24.

Depending on the application, the cure time of the adhesive can be widely varied. In those applications where a rapid cure is desired, a polyol with a high hydroxyl value, e.g., from 135 to 190 can be used. Also, the amount of the A component can be increased to obtain the fast cure times, e.g., the amount of the A component can be selected from 25 to 45 weight parts per 75 to 55 weight parts of the B component to reduce the cure time. Preferably, the reactant components and their relative proportions are selected to provide adhesives having cure times from 1 to about 360 minutes, most preferably from 2 to about 60 minutes.

The adhesive composition can be applied to surfaces of widely varied materials, including metal, plastic, wood and wood fibers, concrete, stone, ceramics, tile, paper, cardboard, fabrics and textiles, cured foam, membranes, etc. and any other natural and mand-made materials. It can be foamed to any degree desired to serve as a sealant and an adhesive simply by adjustment of the proportions of reactants as already set forth herein. The adhesive composition has numerous uses the roofing, construction, insulation, waterproofing, sealant, adhesive, manufacturing, automotive, aviation, marine and furniture industries. For example, the adhesive composition may be used, without limitation, for connection of insulation panels and membranes to substrates, connection of tile shingles, cavity insulation, flooring adhesive, adhesive for flooring systems, foam air barriers, SIPS and foam core building panels, foam core door panels, foam core metal panels, bedliners, metal surface preparation, foam core panels, wood-wood adhesive, milled foam components, and numerous other uses.

The A and B components can be marketed in separate containers sized in conformity to the relative proportions of the components which are desired in the final adhesive and can be manually mixed prior to or during application. In a preferred embodiment, the A and B components are packaged in a two side-by-side cylinders which are secured together in a single package and which have dispensing plungers secured to a common dispensing handle. The cylinder contents are extruded from their respective cylinders into a static mixer and the mixture is dispensed through a single nozzle for application.

Some of the embodiments of this disclosure will be described by the following examples:

### Example 1

An adhesive composition is prepared from the following B side reactant:

| Component | Concentration (weight per 100 parts) |
|---|---|
| Hydroxylated Soyoil¹ | 92.8 |
| Water | 4.0 |
| Polycat 5² | 2.0 |
| Surfactant³ | 1.0 |
| Tin Catalyst⁴ | 0.2 |

¹hydroxyl number = 190
²pentamethyl diethylene diamine
³silicone polyether
⁴dibutyltin dilaurate

This B side reactant was admixed with an A side reactant comprising a MDI (diphenylmethane diisocyanate) polyisocyanate (Mondur MR) in proportions of 20 parts A side and 80 parts B side and the mixture was applied to the paper facer on a polyurethane foam construction board, and on a concrete surface. The adhesive cured in approximately 2 minutes and when one attempted to peel the adhesive from a concrete surface, it exhibited greater adhesion than the adhesive between the paper facer and the foam, since the paper facer separated from the foam board. The B component has a biobased content 93% and the admixed adhesive has a VOC of less than 1%.

### Example 2

An adhesive composition is prepared from the following B side reactant:

| Component | Concentration (weights per 100) |
|---|---|
| Hydroxylated Soyoil¹ | 84.4 |
| Phosphated soy² | 10.0 |
| Dabco 33 LV³ | 4.0 |
| Water | 1.0 |
| Surfactant⁴ | 0.5 |
| Tin Catalyst⁵ | 0.1 |

¹hydroxyl number = 170
²phosphorus content = 1%
³triethylenediamine
⁴silicone polyether
⁵dibutyl tin dilaurate

This B side reactant was admixed with an A side reactant comprising a MDI (diphenylmethane diisocyanate) polyisocyanate (Mondur 489) in proportions of 28 parts A side and 72 parts B side and the mixture was applied to a metal roofing panel which was secured to a metal framing component. The adhesion was adequate to reduce the number of metal fasteners by half of the normal numbers used. The adhesive cured in approximately 8 minutes. The B side component has a biobased content of 93% and the admixed adhesive has a VOC of less than 2%

### Example 3

An adhesive composition is formed from the following B side reactant:

| Component | Concentration (weights per 100 parts) |
|---|---|
| Hydoxylated Soyoil¹ | 98.2 |
| Water | 1.0 |
| Polycat 5² | 0.5 |
| Tin Catalyst³ | 0.3 |

¹hydoxyl number = 55
²pentamethyl diethylene triamine
³dibutyl tin dilaurate

This B side reactant was admixed with an A side reactant comprising Mondur MR in proportions of 12 parts of Side A and 88 parts of side B. The adhesive was applied to a fiber and foam carpet backing and full adhesion took place in 3 hours allowing adequate time apply adhesive and reposition or roll carpet flat on to a wood or concrete floor. The B side component has a biobased content of over 98% and the admixed adhesive has a VOC of less than 1%.

### Example 4

An adhesive composition is prepared from the following B side reactant:

| Component | Concentration (weight parts per 100) |
|---|---|
| Hydroxylated Soyoil¹ | 85.25 |
| Water | 11.0 |
| Dabco 33 LV² | 1.0 |
| Polycat 5³ | 1.5 |
| Tin catalyst⁴ | 0.3 |
| Surfactant⁵ | 0.75 |
| Mondur MR⁶ | 0.2 |

¹hydroxyl number = 190
²triethylenediamine
³pentamethyl diethylene triamine
⁴dibutyl tin dilaurate
⁵silicone polyther
⁶polyisocyanate

The B side reactant was admixed with an A side reactant comprising Mondur MR is proportions of 30 parts of A side to 70 parts of B side.

The above B side reactant mixture showed excellent stability with no separation of water from other components after six months of aging. The adhesive properties of the B side reactant admixed with the A side reactant were excellent with a full cure time of 5 minutes. The B component has a biobased content of over 85% and the admixed adhesive has a VOC of less than 1%.

Adhesive components are packaged separately and can be packaged in a number of different configurations. For example, in one embodiment, a unitary applicator may use separate containers sized to accommodate the unequal proportions of the A and B sides. In another embodiment, the B side reactant can be packaged similar to a caulking cylinder and the A side reactant can be packaged in a cylinder of lesser diameter or small discharge nozzle to provide ¼ volume of the B side reactant which can be secured piggyback to the B side caulking cylinder, with both cylinders discharging into a common extruder mixer. A dispensing tool similar to a modified conventional caulking gun with a second plunger for the piggyback A side cylinder can be used to extrude the components in the proper proportions. In another embodiment, containers for both the A side and B side could be configured for discharge in larger quantities. For example, drums, such as a conventionally sized 55 gallon drum, for the A side and B side could be pumped from the drums using a progressive cavity pump or other pump designed to handle high viscosity liquids with the A side and B side pumped through a static mixer and into a high viscosity spray gun. This embodiment will facilitate the use of the polyurethane adhesive over large areas, and significantly reduce costs compared to smaller delivery systems. This type of spraying may be used for, by way of example only, and not limiting in any manner, bed liners, concrete tanks, adherence for roofing membranes or any other large surface area.

When water is included in the B side component, it is preferred to mix a trace amount of the A side component into the B side component during packaging to stabilize the component against phase separation. For this purpose, approximately 0.1 to 1 weight percent of the A side component is added to the B side component; an amount insufficient to initiate reaction, but sufficient to stabilize against phase separation, presumably by hydrogen bonding.

The foregoing examples have been provided merely for the purpose of explanation, and are in no way to be construed as limiting of the present disclosure. While described with reference to various embodiments, it is understood that the words, which have been used herein, are words of description and illustration, rather than words of limitation. Further, although the invention has been described herein with reference to particular means, materials, and embodiments, the disclosure is not intended to be limited to the particulars set forth herein; rather, the disclosure extends to all functionally equivalent structures, methods and uses. Those skilled in the art, having the benefit of the teachings of this disclosure, may affect numerous modifications thereto and changes may be made without departing from the scope and spirit of the aspects hereof.

Any other undisclosed or incidental details of the construction or composition of the various elements of any embodiment of the present disclosure are not believed to be critical to the achievement of the advantages hereof, so long as the elements possess the attributes needed for them to perform as disclosed. Certainly, one skilled in the field would be able to conceive of a wide variety of alternative configurations and successful combinations thereof. The selection of these and other details of construction are believed to be well within the ability of one of even rudimental skills in this area, in view of the present disclosure. Illustrative embodiments have been described in considerable detail for the purpose of disclosing a practical, operative composition whereby this disclosure may be practiced advantageously. The examples described herein are intended to be exemplary only. The novel characteristics of the disclosure may be incorporated in other forms without departing from the spirit and scope of the disclosure. This disclosure encompasses embodiments both comprising and consisting of the elements described with reference to the illustrative embodiments. All technical terms shall take on their customary meaning as established by the appropriate technical discipline utilized by those normally skilled in that particular art area.

What is claimed is:

1. A polyurethane adhesive comprising:
an A side component comprising a reactive organic diisocyanate; and
a B side component comprising:
a hydroxylated plant-based oil having a hydroxyl number from 50 to about 190 mg/g in an amount from 60 to 90 weight percent;
a phosphated plant-based oil containing from 0.5 to about 2.0 weight percent phosphorous in an amount from 0 to about 15 weight percent;
a catalyst;
a surfactant;
water; and
a trace amount of the A side component.

2. The polyurethane adhesive of claim 1, wherein the organic diisocyanate is diphenylmethane diisocyanate.

3. The polyurethane adhesive of claim 1, wherein the water is in a concentration from 0.5 to 15 weight percent.

4. The polyurethane adhesive of claim 1, wherein the catalyst is an organic metal catalyst.

5. The polyurethane adhesive of claim 4, wherein the organic metal catalyst is an organic tin compound.

6. The polyurethane adhesive of claim 5, wherein the organic tin compound is an alkyl diethylene diamine catalyst in a concentration from 0.1 to 4 weight percent.

7. The polyurethane adhesive of claim 1, wherein the catalyst is an amine catalyst.

8. The polyurethane adhesive of claim 1, wherein the catalyst is triethylenediamine.

9. The polyurethane adhesive of claim 1, wherein the B side component further comprises a combination of two or more catalysts.

10. The polyurethane adhesive of claim 9, wherein the catalysts are dibutyl tin dilaurate and pentamethyl diethylene diamine in combination.

11. The polyurethane adhesive of claim 1, wherein the A side component is present in an amount of approximately 24 weight parts and the B side component is present in an amount of approximately 72 weight parts.

12. The polyurethane adhesive of claim 1, wherein the hydroxylated plant-based oil is soybean oil.

13. The polyurethane adhesive of claim 12, wherein the soybean oil has a hydroxyl value from 50 to 190 mg/g.

14. The polyurethane adhesive of claim 1, wherein the phosphated plant-based oil is soybean oil.

15. The polyurethane adhesive of claim 1, wherein the surfactant is a silicone surfactant.

16. The polyurethane adhesive of claim 1, wherein the surfactant is silicone polyether.

17. The polyurethane adhesive of claim 1, wherein the trace amount of side A component is present in the B side in an amount of approximately 0.1 to 1 weight percent.

18. The polyurethane adhesive of claim 1, wherein the B side component has a minimum biobased content of 80% as determined by radio carbon and isotope ratio mass spectrometry in accordance with ASTM D6866-04 or any other suitable methods.

19. The polyurethane adhesive of claim 1, comprising a volatile organic concentration of less than 2% as determined in accordance with ASTM Method 24.

20. The polyurethane adhesive of claim 1, comprising no petrochemical based polyols.

21. A polyurethane adhesive comprising:
an A side component comprising a reactive organic diisocyanate; and
a B side component comprising:
a hydroxylated plant-based oil having a hydroxyl number from 50 to about 190 mg/g in an amount from 60 to 90 weight percent;
a phosphated plant-based oil containing from 0.5 to about 2.0 weight percent phosphorous in an amount from 0 to about 15 weight percent; and
optionally, at least one of a catalyst, a surfactant, water and a trace amount of the A side component.
